(19) United States
(12) Patent Application Publication
(10) Pub. No.: US 2007/0217358 A1
(43) Pub. Date: Sep. 20, 2007

(54) Data transmission

(75) Inventors: Jeroen Wigard, Aalborg (DK); Pekka Marjelund, Muijala (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/439,172

(22) Filed: May 24, 2006

(30) Foreign Application Priority Data
Mar. 17, 2006 (FI) 20065174

(51) Int. Cl. H04Q 7/00

(52) U.S. Cl. 370/329

(57) ABSTRACT

A radio system may provide dedicated uplink channels and HSUPA channels for user terminals. When the radio resource controller receives a request for an uplink transmission of an HSUPA channel, the radio resource controller may allow the uplink transmission through the HSUPA channel if the total throughput of the HSUPA channels is below a predetermined threshold.

### FIELD

The invention relates to a data transmission method, a radio system, a radio access controller, a packet scheduler and a computer program for the data transmission.

### BACKGROUND

A DCH (Dedicated Channel) is used for transmitting user or control information between the network infrastructure of the radio system and a user terminal, and its enhanced counterpart is an EDCH (Enhanced Dedicated Channel). The HSUPA (High-Speed Uplink Packet Access), in turn, is a data access concept for providing an exceedingly high-speed packet-switched data service in an uplink of a WCDMA (Wideband Code Division Multiple Access) radio system. It is comparable to an HSDPA (High-Speed Downlink Packet Access) and together with the HSDPA they are capable of providing a nearly symmetric high-speed service between user equipment and a network infra-structure.

An uplink packet data transfer mechanism in the HSUPA is provided by the enhanced DCH channel (Dedicated Channel) including at least one E-DPDCH channel (Enhanced Dedicated Physical Data Channel) and one E-DPCCH channel (Dedicated Physical Control Channel) in order to share radio resources with the WCDMA uplink physical data channels.

The packet scheduler of the DCH is located in an RNC. However, the packet scheduler's ability is limited to adapt to the instantaneous variations in traffic between the node B and the user terminal. The packet scheduler is conservative in allocating uplink resources to accommodate the variations, to avoid congestion and overload and to take into account the influence from inactive users in the following scheduling period. Yet, that turns out to be spectrally inefficient for high allocated data-rates and long release timer values.

A packet scheduler of the HSUPA is located in a node B and its functionality is used to take care of allocating uplink resources in the cell, which enhances the uplink throughput. In this case, the radio network controller sets a maximum received power level that the node B may not exceed. The packet scheduler of the node B then allows or denies a permission of packet transmissions such that the total received power, resulting from the DCH and the EDCH, stays below this maximum power level.

There are, however, problems related to these solutions, too. The measured received power levels in the node B are not always accurate and vary due to variations in load of, for example, neighboring cells. In an environment having a largely varying interference, throughput in the cell, which can be measured, for instance, as data rate, typically remains lower than it could be. Users may also be blocked out of the HSUPA service.

### BRIEF DESCRIPTION OF THE INVENTION

An object of the invention is to provide an improved data transmission method, an improved radio system, an improved radio resource controller, an improved packet scheduler and an improved computer program for the data transmission method. According to an aspect of the invention, there is provided a data transmission method in a radio system including user terminals and at least one base station, the radio system providing dedicated uplink packet access channels and High-Speed Uplink Packet Access channels for user terminals, the High-Speed Uplink Packet Access channels having a higher maximum data rates than the dedicated uplink packet access channels, the method comprising receiving, by a packet scheduler of a cell in an infrastructure of the radio system, a request for an uplink transmission of a High-Speed Uplink Packet Access channel. The method further comprises allowing, by the packet scheduler, the uplink transmission through a High-Speed Uplink Packet Access channel if the total throughput of High-Speed Uplink Packet Access channels of the cell is below a predetermined threshold.

According to another aspect of the invention, there is provided a data transmission method in a radio system including user terminals and at least one base station, the radio system providing individual uplink channels and upgraded individual uplink channels for user terminals, the upgraded individual uplink channels having a higher maximum data rate than the individual uplink channels, the method comprising receiving, by a radio resource controller of a cell in an infrastructure of the radio system, a request for an uplink transmission of an upgraded individual uplink channel. The method further comprises allowing, by the radio resource controller, the uplink transmission through an upgraded individual uplink channel if the total throughput of upgraded individual uplink channels of the cell is below a predetermined threshold.

According to another aspect of the invention, there is provided a radio system including user terminals and at least one base station in an infra-structure of the radio system, the radio system being configured to provide dedicated uplink packet access channels and High-Speed Uplink Packet Access channels for user terminals, the High-Speed Uplink Packet Access channels having higher maximum data rates than the dedicated uplink packet access channels, the radio system comprising a packet scheduler of a cell in the infrastructure of the radio system, the packet scheduler being configured to receive a request for an uplink transmission of a High-Speed Uplink Packet Access channel. The packet scheduler is configured to allow the uplink transmission through a High-Speed Uplink Packet Access channel if the total throughput of High-Speed Uplink Packet Access channels is below a predetermined threshold.

According to another aspect of the invention, there is provided a radio system including user terminals and at least one base station, the radio system being configured to provide individual uplink channels and upgraded individual uplink channels for user terminals, the upgraded individual uplink channels having a higher maximum data rate than the individual uplink channels, the radio system comprising a radio resource controller of a cell in an infra-structure of the radio system, the radio resource controller being configured to receive a request for an uplink transmission of an upgraded individual uplink channel. The radio resource controller is configured to allow the uplink transmission through an upgraded individual uplink channel if the total throughput of upgraded individual uplink channels is below a predetermined threshold.

According to another aspect of the invention, there is provided a packet scheduler in a radio system including user terminals and at least one base station, the radio system being configured to provide individual uplink channels and upgraded individual uplink channels for user terminals, the upgraded individual uplink channels having a higher maximum data rate than the individual uplink channels, the packet scheduler being configured to receive a request for an uplink transmission of an upgraded individual uplink channel. The packet scheduler is configured to allow the uplink transmission through an upgraded individual uplink channel if the total throughput of upgraded individual uplink channels is below a predetermined threshold.

According to another aspect of the invention, there is provided a radio resource controller in a radio system including user terminals and at least one base station, the radio system being configured to provide individual uplink channels and upgraded individual uplink channels for user terminals, the upgraded individual uplink channels having a higher maximum data rate than the individual uplink channels, the radio resource controller being configured to receive a request for an uplink transmission of an upgraded individual uplink channel. The radio resource controller is configured to allow the uplink transmission through an upgraded individual uplink channel if the total throughput of upgraded individual uplink channels is below a predetermined threshold.

According to another aspect of the invention, there is provided a radio system including user terminals and at least one base station in an infra-structure of the radio system, the radio system being configured to provide dedicated uplink packet access channels and High-Speed Uplink Packet Access channels for user terminals, the High-Speed Uplink Packet Access channels having higher maximum data rates than the dedicated uplink packet access channels, the radio system comprising a means for scheduling in a cell of the infrastructure of the radio system, the packet scheduler being configured to receive a request for an uplink transmission of a High-Speed Uplink Packet Access channel. The means for scheduling is configured to allow the uplink transmission through a High-Speed Uplink Packet Access channel if the total throughput of High-Speed Uplink Packet Access channels is below a predetermined threshold.

According to another aspect of the invention, there is provided a radio system including user terminals and at least one base station, the radio system being configured to provide individual uplink channels and upgraded individual uplink channels for user terminals, the upgraded individual uplink channels having a higher maximum data rate than the individual uplink channels, the radio system comprising a means for controlling a cell in an infra-structure of the radio system, the radio resource controller being configured to receive a request for an uplink transmission of an upgraded individual uplink channel. The means for controlling is configured to allow the uplink transmission through an upgraded individual uplink channel if the total throughput of upgraded individual uplink channels is below a predetermined threshold.

According to another aspect of the invention, there is provided a computer program product encoding a computer program of instructions for executing a computer process for providing dedicated uplink packet access channels and High-Speed Uplink Packet Access channels for user terminals in a radio system including user terminals and at least one base station, the High-Speed Uplink Packet Access channels having higher maximum data rates than the dedicated uplink packet access channels; performing the process after receiving by a packet scheduler of a cell in an infrastructure of the radio system a request for an uplink transmission of a High-Speed Uplink Packet Access channel. The computer process further comprises allowing the uplink transmission through a High-Speed Uplink Packet Access channel if the total throughput of High-Speed Uplink Packet Access channels of the cell is below a predetermined threshold.

According to another aspect of the invention, there is provided a computer program product encoding a computer program of instructions for executing a computer process for providing individual uplink channels and upgraded individual uplink channels for user terminals, the upgraded individual uplink channels having a higher maximum data rate than the individual uplink channels; performing the process after receiving by a radio resource controller of a cell in an infrastructure of the radio system a request for an uplink transmission of an upgraded individual uplink channel. The computer process further comprises allowing the uplink transmission through an upgraded individual uplink channel if the total throughput of upgraded individual uplink channels of the cell is below a predetermined threshold.

According to another aspect of the invention, there is provided a computer program distribution medium readable by a computer and encoding a computer program of instructions for executing a computer process for providing dedicated uplink packet access channels and High-Speed Uplink Packet Access channels for user terminals in a radio system including user terminals and at least one base station, the High-Speed Uplink Packet Access channels having higher maximum data rates than the dedicated uplink packet access channels; performing the process after receiving by a packet scheduler of a cell in an infrastructure of the radio system a request for an uplink transmission of a High-Speed Uplink Packet Access channel. The computer process further comprises allowing the uplink transmission through a High-Speed Uplink Packet Access channel if the total throughput of High-Speed Uplink Packet Access channels of the cell is below a predetermined threshold.

According to another aspect of the invention, there is provided a computer program distribution medium readable by a computer and encoding a computer program of instructions for executing a computer process for providing individual uplink channels and upgraded individual uplink channels for user terminals, the upgraded individual uplink channels having a higher maximum data rate than the individual uplink channels; performing the process after receiving by a radio resource controller of a cell in an infrastructure of the radio system a request for an uplink transmission of an upgraded individual uplink channel. The computer process further comprises allowing the uplink transmission through an upgraded individual uplink channel if the total throughput of upgraded individual uplink channels of the cell is below a predetermined threshold.

The invention provides several advantages. The use of the high-speed channels becomes more efficient. A large throughput of the upgraded uplink channel, such as the HSUPA channel, is also possible in an environment with varying interference.

### LIST OF DRAWINGS

In the following, the invention will be described in greater detail with reference to the embodiments and the accompanying drawings, in which

FIG. 1 shows a radio system;

FIG. 2 illustrates radio resources and their control;

FIG. 3 illustrates a flow chart of the method an HSUPA channel; and

FIG. 4 illustrates a flow chart of the method utilizing an upgraded individual uplink channel.

### DESCRIPTION OF EMBODIMENTS

FIG. 1 illustrates an example of a wireless telecommunications system to which the present solution may be applied. Embodiments can be utilized in the UMTS (Universal Mobile Telecommunications System) or in a WCDMA radio system which are examples of wireless telecommunication systems. The present solution may, however, be applied to any wireless telecommunications system that supports an upgraded uplink access principle such as the HSUPA protocol.

With reference to FIG. 1, a typical radio system may comprise user equipment 100 to 104, at least one node B 106, and a radio network controller (RNC) 108. More generally, the user equipment 100 to 104 can also be called a user terminal. The node B can be called a base station and the radio network controller can be called a base station controller. The latter terms will be used in the application from now on.

The user terminals 100 to 104 may be fixedly installed terminals, user terminals installed in vehicles or portable mobile terminals. The user terminal 100 to 104 may include two parts: mobile equipment (ME) and a UMTS subscriber identity module (USIM). The mobile equipment 100 to 104 typically includes radio frequency parts (RF) for providing the air interface. The user terminal 100 to 104 may further include a digital signal processor, memory, and computer programs for executing computer processes. The user equipment 100 to 104 also comprises an antenna, a user interface, and a battery not shown in FIG. 1. The USIM may comprise user-related information and information related to information security in particular, for instance, an encryption algorithm.

Many functions in the base station controller 108 may be implemented with a digital signal processor, memory, and computer programs for executing computer processes. In a similar manner, many functions in the base station 106 may be implemented with a digital signal processor, memory, and computer programs for executing computer processes.

The base station 106 can be connected to the base station controller 108 by a digital transmission link 116.

The user terminal 100 to 104 can communicate with the base station 106 of the network infrastructure over an uplink physical data channel using signals 110 to 114. A network infrastructure of the radio system can be considered to include all other elements of the radio system except the user terminals 100 to 104, which are usually mobile. The signals 110 to 114 between the user terminals 100 to 104 and the base station 106 may carry digitized information, which is e.g. speech or data information produced by subscribers or control information produced by the radio system.

The user terminal 100 to 104 may communicate with at least one base station 106 on the basis of packet-switching, such as a GPRS (General Packet Radio Service) method. Data in packets may contain address and control data in addition to the actual traffic data. Several connections may employ the same transmission channel simultaneously. A packet-switching method is suitable for data transmission where the data to be transmitted is generated in bursts. In such a case, it is not necessary to allocate a data link for the entire duration of transmission but only for the time it takes to transmit the packets or data blocks as they may also be called. After reception of a data block, a CRC (Cyclic Redundancy Check) procedure, for example, can be used to test the success of the reception of the block. A block acknowledgement message may be generated for each data block on the basis of the test. If the data block were received successfully, the block acknowledgement message indicates acknowledgement (ACK). If the data block was received unsuccessfully, the block acknowledgement message indicates non-acknowledgement (NACK).

The radio system can provide individual uplink channels and upgraded individual uplink channels for user terminals using the packet-switching. The upgraded individual uplink channels have a higher maximum data rate than the individual uplink channels. An individual uplink channel may be a dedicated channel is for only one user terminal. The individual uplink channel may be such as a DPDCH (Dedicated Physical Data channel) defined in the 3GPP specification. The uplink physical data channel represents a conventional data channel that as such excludes the use of the HSUPA concept. The uplink physical data channel can be used for both high and low priority services, such as conversational class speech services and RRC (Radio Resource Signalling), in relation to the HSUPA data transfer capacity.

An upgraded individual uplink channel may be a physical HSUPA channel, such as an E-DPDCH (Enhanced Dedicated Physical Data Channel) defined in the 3GPP specification. The E-DPDCH transfers data blocks in predetermined temporal intervals, such as a TTI (Transmission Time Interval).

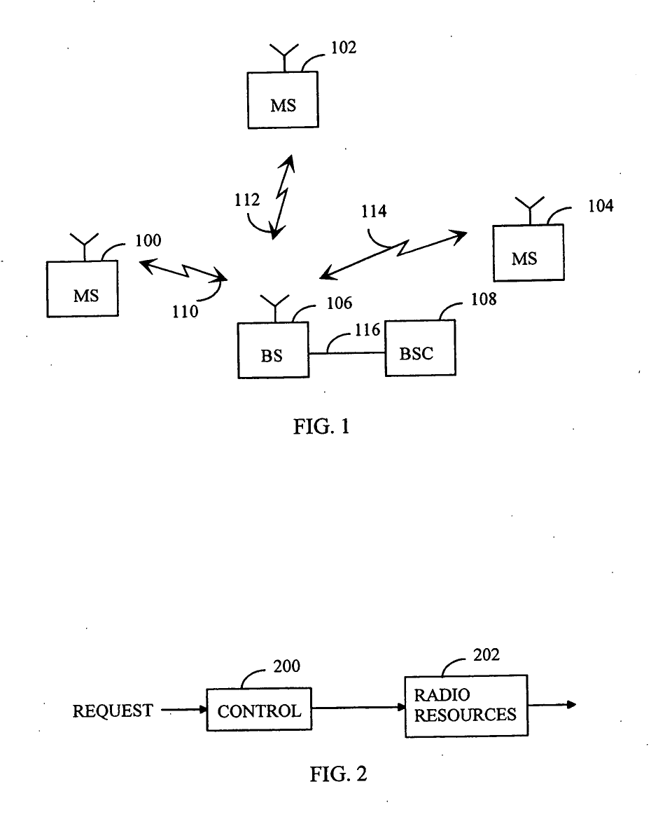

Referring to FIG. 2, the radio system may include a radio resource controller 200 of a cell in an infrastructure of the radio system and radio resources 202. The radio resource controller 200 may control the radio access and hence it may also be called a radio access controller. The radio resource controller 200 may also be referred to as a packet scheduler. When the radio resource controller 200 receives a request for an uplink transmission of an upgraded individual uplink from a user terminal, the radio resource controller 200 may allow the uplink transmission through an upgraded individual uplink channel if the total throughput of the upgraded individual uplink channels is below a predetermined threshold. The throughput may be measured, for example, as a total L1 bit rate in the cell. The layer L1 refers to the physical layer of the OSI model (Open Systems Interconnection).

The radio resource controller 200 also has or receives information on a total throughput through upgraded individual uplink channels of the cell, and a predetermined threshold relating to the total throughput, since the base station knows the allocated and selected bit rates of the users.

The predetermined threshold defines a minimum throughput (i.e. the total L1 bit rate) which can scheduled or guaranteed without paying attention to the power resources.

The throughput, such as the total L1 bit rate, can be considered as the amount of data transmitted from one place and received successfully in a desired place. Usually it is also assumed that the data is successfully moved between the places in a given time period. The throughput can be measured in terms of a data transfer rate which can be expressed in bps (Bits Per Second).

If the radio resource controller 200 allows the uplink transmission, the radio resource controller 200 allocates the necessary radio resources 202, such as a channel, a frequency, a time slot, a spread code, a modulation, received power for a certain period of time, etc. for each packet of the transmission. The radio resources 202 can be found in the PDCP (Packet Data Convergence Protocol) layer, RLC (Radio Link Control) layer, MAC layer and/or PHYS (Physical) layer according to the OSI (Open Standards Interconnect) protocol model. Physically, the radio resource controller 200 can reside in the base station controller, in the base station or partly in both. Correspondingly, a part of the allocation may comprise a fast scheduling (shorter TTI) performed in the base station.

The base station may measure a total received power level of the cell. The received total wide band power Prx_total can be defined as the wide band power received through a filter determining the band of the reception. The filter may be a pulse shaping filter of the base station.

Assume that a HSUPA channel is an example of an upgraded individual uplink channel and a dedicated uplink channel is an example of an individual uplink channel. In an embodiment, the allowance to use an upgraded uplink channel is at least partly not based on the total received power. Hence, for example, a permission to send data in an HSUPA channel may be granted for a user terminal regardless of the total received power level of the cell, if the total throughput of the HSUPA channels is below the predetermined threshold.

However, a decision may be made, for example, in the packet scheduler or the like, to allow or to deny the uplink transmission through an HSUPA channel and the decision may be based on the total received power level of the cell if the total throughput of the HSUPA channels of the cell is at or above the predetermined threshold.

The value of the predetermined threshold may be adaptive and the value may be changed as a function of the total throughput of the dedicated uplink packet access channels. The change of the value may be made in the base station or in the base station controller. The change of the value of the predetermined threshold may be performed in a base station controller, which may transmit a parameter specifying the value of the predetermined threshold to a base station for the use of the packet scheduler in the base station.

A combined threshold for the dedicated uplink packet access channels and the HSUPA channels may be formed in the base station controller, which may transmit the combined threshold to a base station. The base station determines the throughput of the dedicated uplink packet access channels because the base station knows the connections with the user terminals. Hence, the base station may form the predetermined threshold of the HSUPA as a function of a difference relating to the combined threshold for the dedicated uplink packet access channels and the HSUPA channels and the throughput of the dedicated uplink packet access channels.

The value of the predetermined threshold may be increased if the total throughput of dedicated uplink packet access channels decreases more than a predetermined descent when the loading of the cell is higher than a predetermined loading level. The descent may be, for example, 100 kbps. The value of the predetermined threshold may be increased as much as the loading is decreased during the descent in principle. The increase of the predetermined threshold, however, depends additionally on the ratio between the signal and the noise measured, for example, on the Eb/No (Energy per bit per noise power spectral density). If the Eb/No is constant, it is possible to increase the value of the predetermined threshold with the value of descent.

The value of the predetermined threshold may be decreased if a total throughput of dedicated uplink packet access channels increases more than a predetermined ascent when the loading of the cell is higher than a predetermined loading level. The ascent may be, for example, 100 kbps. Corresponding to the increase of the predetermined threshold, it is possible to decrease the value of the predetermined threshold with the value of ascent.

Loading of a cell can be measured by an effective data rate which can be measured as bits per second. Hence, the predetermined loading level may be a predetermined effective data rate received by the cell. It can be assumed that one user terminal can transmit at the rate of 100 kbps and there are five user terminals transmitting through the HSUPA channels on the average at the same time. The predetermined loading level of the HSUPA channels may then be, for instance, 500 kbps if the maximum loading level of the cell is assumed to be 2 Mbps. Similarly, if no DCH traffic is present, the loading level may be around 1500 kbps. Alternatively or additionally, loading of a cell can be measured by a total received power of the cell. Then, the predetermined loading level may be a predetermined total power level received by the cell.

At least one of the following can form some piece of information on the total throughput of the upgraded uplink channels, such as the HSUPA channels of the cell: a base station, a base station controller.

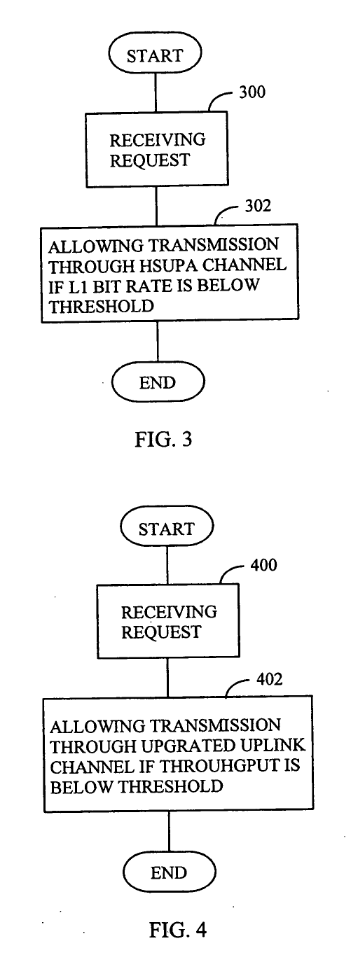

FIG. 3 presents a flow chart of the method utilizing an HSUPA channel. In step 300, a request for an uplink transmission of an HSUPA channel is received by a packet scheduler of a cell in an infrastructure of the radio system. In step 302, the uplink transmission through an HSUPA channel is allowed by the packet scheduler if the total throughput of HSUPA channels of the cell is below a predetermined threshold.

FIG. 4 presents a flow chart of the method utilizing an upgraded individual uplink channel. In step 400, a request for an uplink transmission of an upgraded individual uplink channel is received by a radio resource controller of a cell in an infrastructure of the radio system. In step 402, the uplink transmission through an upgraded individual uplink channel is allowed by the radio resource controller if the total throughput of upgraded individual uplink channels of the cell is below a predetermined threshold.

The embodiments of the methods may be implemented as computer programs comprising instructions for executing a computer process for providing individual uplink channels, such as dedicated uplink packet access channels and upgraded individual uplink channels, such as the HSUPA channels, for user terminals, the upgraded individual uplink channels having higher maximum data rates and hence a higher throughput than the individual uplink channels.

A computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but it can be modified in several ways within the scope of the appended claims.

1. A data transmission method in a radio system including user terminals and at least one base station, the radio system providing dedicated uplink packet access channels and High-Speed Uplink Packet Access channels for user terminals, the High-Speed Uplink Packet Access channels having a higher maximum data rates than the dedicated uplink packet access channels, the method comprising
receiving, by a packet scheduler of a cell in an infrastructure of the radio system, a request for an uplink transmission of a High-Speed Uplink Packet Access channel, characterized by
allowing, by the packet scheduler, the uplink transmission through a High-Speed Uplink Packet Access channel if the total throughput of High-Speed Uplink Packet Access channels of the cell is below a predetermined threshold.

2. A data transmission method in a radio system including user terminals and at least one base station, the radio system providing individual uplink channels and upgraded individual uplink channels for user terminals, the upgraded individual uplink channels having a higher maximum data rate than the individual uplink channels, the method comprising
receiving, by a radio resource controller of a cell in an infrastructure of the radio system, a request for an uplink transmission of an upgraded individual uplink channel, characterized by
allowing, by the radio resource controller, the uplink transmission through an upgraded individual uplink channel if the total throughput of upgraded individual uplink channels of the cell is below a predetermined threshold.

3. The method of claim 1, characterized by measuring a total received power level of the cell; performing the allowance regardless of the total received power level of the cell, if the total throughput of the High-Speed Uplink Packet Access channels is below the predetermined threshold; and
deciding, by the packet scheduler, to allow or to deny the uplink transmission through a High-Speed Uplink Packet Access channel based on the total received power level of the cell if the total throughput of High-Speed Uplink Packet Access channels of the cell is at or above the predetermined threshold.

4. The method of claim 1, characterized by changing the value of the predetermined threshold as a function of the total throughput of dedicated uplink packet access channels.

5. The method of claim 4, characterized by performing the change of the value of the predetermined threshold in a base station controller, transmitting a parameter specifying the value of the predetermined threshold to a base station and performing the allowance of the uplink transmission through a High-Speed Uplink Packet Access channel by the packet scheduler in the base station.

6. The method of claim 4, characterized by forming a combined threshold for the dedicated uplink packet access channels and the High-Speed Uplink Packet Access channels in the base station controller, transmitting the combined threshold to a base station, determining a throughput of the dedicated uplink packet access channels in the base station, and forming the predetermined threshold as a function difference relating to the combined threshold for the dedicated uplink packet access channels and the High-Speed Uplink Packet Access channels, and the throughput of the dedicated uplink packet access channels.

7. The method of claim 4, characterized by increasing the value of the predetermined threshold if the total throughput of dedicated uplink packet access channels decreases more than a predetermined descent when the loading of the cell is higher than a predetermined loading level.

8. The method of claim 4, characterized by decreasing the value of the predetermined threshold if the total throughput of dedicated uplink packet access channels increases more than a predetermined ascent when the loading of the cell is higher than a predetermined loading level.

9. The method of claim 7 or 8, characterized by measuring loading of a cell by an effective data rate, the predetermined loading level being a predetermined effective data rate received by the cell.

10. The method of claim 7 or 8, characterized by measuring loading of a cell by the total received power of the cell, the predetermined loading level being a predetermined total power level received by the cell.

11. The method of claim 1, characterized by forming information on the total throughput of High-Speed Uplink Packet Access channels of the cell in at least one of the following: a base station, a base station controller.

12. A radio system including user terminals and at least one base station in an infrastructure of the radio system, the radio system being configured to provide dedicated uplink packet access channels and High-Speed Uplink Packet Access channels for user terminals, the High-Speed Uplink Packet Access channels having higher maximum data rates than the dedicated uplink packet access channels, the radio system comprising a packet scheduler of a cell in the infrastructure of the radio system, the packet scheduler being configured to receive a request for an uplink transmission of a High-Speed Uplink Packet Access channel, characterized in that
the packet scheduler is configured to allow the uplink transmission through a High-Speed Uplink Packet Access channel if the total throughput of High-Speed Uplink Packet Access channels is below a predetermined threshold.

13. A radio system including user terminals and at least one base station, the radio system being configured to provide individual uplink channels and upgraded individual uplink channels for user terminals, the upgraded individual uplink channels having a higher maximum data rate than the individual uplink channels, the radio system comprising a radio resource controller of a cell in an infrastructure of the radio system, the radio resource controller being configured to receive a request for an uplink transmission of an upgraded individual uplink channel, characterized in that the radio resource controller is configured to allow the uplink transmission through an upgraded individual uplink channel if the total throughput of upgraded individual uplink channels is below a predetermined threshold.

14. The radio system of claim 12, characterized in that the packet scheduler is configured to perform the allowance regardless of the total received power level of the cell, if the total throughput of the High-Speed Uplink Packet Access channels is below the predetermined threshold; and
the packet scheduler is configured to allow or to deny the uplink transmission through a High-Speed Uplink Packet Access channel based on the total received power level of the cell if the total throughput of High-Speed Uplink Packet Access channels of the cell is at or above the predetermined threshold.

15. The radio system of claim 12, characterized in that the base station controller is configured to change the value of the predetermined threshold as a function of the total throughput of dedicated uplink packet access channels and to transmit a parameter specifying the value of the predetermined threshold to a base station where the packet scheduler is configured to perform the allowance of the uplink transmission through a High-Speed Uplink Packet Access channel.

16. The radio system of claim 15, characterized in that the base station controller is configured to form a combined threshold for the dedicated uplink packet access channels and the High-Speed Uplink Packet Access channels and to transmit the combined threshold to a base station, and the base station is configured to form a threshold of the dedicated uplink packet access channels, and to form the predetermined threshold as a function of a difference relating to the combined threshold for the dedicated uplink packet access channels and the High-Speed Uplink Packet Access channels and the threshold of the dedicated uplink packet access channels.

17. The radio system of claim 15, characterized in that the base station controller is configured to increase the value of the predetermined threshold if the total throughput of dedicated uplink packet access channels decreases more than a predetermined descent when the loading of the cell is higher than a predetermined loading level.

18. The radio system of claim 15, characterized in that the base station controller is configured to decrease the value of the predetermined threshold if the total throughput of dedicated uplink packet access channels increases more than a predetermined ascent when the loading of the cell is higher than a predetermined loading level.

19. The radio system of claim 17 or 18, characterized in that the base station is configured to measure loading of a cell by an effective data rate, the predetermined loading level being a predetermined effective data rate received by the cell.

20. The radio system of claim 17 or 18, characterized in that the base station is configured to measure loading of a cell by the total received power of the cell, the predetermined loading level being a predetermined total power level received by the cell.

21. The radio system of claim 12, characterized in that at least one of the following is configured to form information on the total throughput of High-Speed Uplink Packet Access channels of the cell: a base station, a base station controller.

22. A packet scheduler in a radio system including user terminals and at least one base station, the radio system being configured to provide individual uplink channels and upgraded individual uplink channels for user terminals, the upgraded individual uplink channels having a higher maximum data rate than the individual uplink channels, the packet scheduler being configured to receive a request for an uplink transmission of an upgraded individual uplink channel, characterized in that the packet scheduler is configured to allow the uplink transmission through an upgraded individual uplink channel if the total throughput of upgraded individual uplink channels is below a predetermined threshold.

23. A radio resource controller in a radio system including user terminals and at least one base station, the radio system being configured to provide individual uplink channels and upgraded individual uplink channels for user terminals, the upgraded individual uplink channels having a higher maximum data rate than the individual uplink channels, the radio resource controller being configured to receive a request for an uplink transmission of an upgraded individual uplink channel, characterized in that the radio resource controller is configured to allow the uplink transmission through an upgraded individual uplink channel if the total throughput of upgraded individual uplink channels is below a predetermined threshold.

24. A radio system including user terminals and at least one base station in an infrastructure of the radio system, the radio system being configured to provide dedicated uplink packet access channels and High-Speed Uplink Packet Access channels for user terminals, the High-Speed Uplink Packet Access channels having higher maximum data rates than the dedicated uplink packet access channels, the radio system comprising a means for scheduling in a cell of the infrastructure of the radio system, the packet scheduler being configured to receive a request for an uplink transmission of a High-Speed Uplink Packet Access channel, characterized in that
the means for scheduling is configured to allow the uplink transmission through a High-Speed Uplink Packet Access channel if the total throughput of High-Speed Uplink Packet Access channels is below a predetermined threshold.

25. A radio system including user terminals and at least one base station, the radio system being configured to provide individual uplink channels and upgraded individual uplink channels for user terminals, the upgraded individual uplink channels having a higher maximum data rate than the individual uplink channels, the radio system comprising a means for controlling a cell in an infrastructure of the radio system, the radio resource controller being configured to receive a request for an uplink transmission of an upgraded individual uplink channel, characterized in that the means for controlling is configured to allow the uplink transmission through an upgraded individual uplink channel if the total throughput of upgraded individual uplink channels is below a predetermined threshold.

26. A computer program product encoding a computer program of instructions for executing a computer process for providing dedicated uplink packet access channels and High-Speed Uplink Packet Access channels for user terminals in a radio system including user terminals and at least one base station, the High-Speed Uplink Packet Access channels having higher maximum data rates than the dedicated uplink packet access channels;
performing the process after receiving by a packet scheduler of a cell in an infrastructure of the radio system a request for an uplink transmission of a High-Speed Uplink Packet Access channel, characterized by
allowing the uplink transmission through a High-Speed Uplink Packet Access channel if the total throughput of High-Speed Uplink Packet Access channels of the cell is below a predetermined threshold.

27. A computer program product encoding a computer program of instructions for executing a computer process for providing individual uplink channels and upgraded individual uplink channels for user terminals, the upgraded individual uplink channels having a higher maximum data rate than the individual uplink channels;
performing the process after receiving by a radio resource controller of a cell in an infrastructure of the radio system a request for an uplink transmission of an upgraded individual uplink channel, characterized by
allowing the uplink transmission through an upgraded individual uplink channel if the total throughput of upgraded individual uplink channels of the cell is below a predetermined threshold.

28. A computer program distribution medium readable by a computer and encoding a computer program of instructions for executing a computer process for providing dedicated uplink packet access channels and High-Speed Uplink Packet Access channels for user terminals in a radio system including user terminals and at least one base station, the High-Speed Uplink Packet Access channels having higher maximum data rates than the dedicated uplink packet access channels;
performing the process after receiving by a packet scheduler of a cell in an infrastructure of the radio system a request for an uplink transmission of a High-Speed Uplink Packet Access channel, characterized by
allowing the uplink transmission through a High-Speed Uplink Packet Access channel if the total throughput of High-Speed Uplink Packet Access channels of the cell is below a predetermined threshold.

29. A computer program distribution medium readable by a computer and encoding a computer program of instructions for executing a computer process for providing individual uplink channels and upgraded individual uplink channels for user terminals, the upgraded individual uplink channels having a higher maximum data rate than the individual uplink channels;
performing the process after receiving by a radio resource controller of a cell in an infrastructure of the radio system a request for an uplink transmission of an upgraded individual uplink channel, characterized by
allowing the uplink transmission through an upgraded individual uplink channel if the total throughput of upgraded individual uplink channels of the cell is below a predetermined threshold.

30. The computer program distribution medium of claim 28 or 29, the distribution medium including at least one of the following media: a computer readable medium, a program storage medium, a record medium, a computer readable memory, a computer readable software distribution package, a computer readable signal, a computer readable telecommunications signal, and a computer readable compressed software package.
